(19) United States
(12) Patent Application Publication
(10) Pub. No.: US 2024/0329830 A1
(43) Pub. Date: Oct. 3, 2024

(54) SYSTEM AND METHOD FOR SEQUENTIAL SIGNING OF DOCUMENTS

(71) Applicant: Certinal Software Private Limited, Mumbai (IN)

(72) Inventors: Krishnendu Chattopadhyaya, Mumbai (IN); Raghav Paruthy, Mumbai (IN)

(73) Assignee: Certinal Software Private Limited, Mumbai (IN)

(21) Appl. No.: 18/620,587

(22) Filed: Mar. 28, 2024

(30) Foreign Application Priority Data
Mar. 29, 2023 (IN) 202321022987

(51) Int. Cl. G06F 3/04883; G06F 16/35; H04L 9/40; H04L 51/08

(52) U.S. Cl. CPC G06F 3/04883; G06F 16/358; H04L 51/08; H04L 63/08; H04L 2463/082

(57) ABSTRACT

A system and method for sequential signing of documents, wherein the sender sends a signature workflow transaction to be signed using at least one input device, where the recipient selects at least one transaction from a pending workflow transactions list displayed by the sequential signature feature on the recipient's web screen, where a 2-factor authentication validates the recipient enabling him/her to apply signature to the documents through a processing unit of the system employing a sequential signature feature providing pending workflow transactions one after the other in a sequential manner, followed by the generation of an audit report and sending the transaction completion conformation email to the sender and recipient using an output device, so as to facilitate the segregation of documents into transactions using metadata field mapping, allowing 2-factor authentication of the recipient and employing sequential transaction workflow for signing multiple pending workflow transactions at the recipient's end.

### CROSS-REFERENCE TO RELATED APPLICATION

The instant application claims priority to Indian Patent Application Serial No. 202321022987, filed Mar. 29, 2023, the entire specification of which is expressly incorporated herein by reference.

### FIELD OF THE INVENTION

The present invention relates to electronic signing of electronic documents. More particularly, the present invention relates to a system and method to perform sequential signing of e-documents which are pending for recipients' action.

### BACKGROUND OF THE INVENTION

Signing of various documents becomes an integral part of the various business transactions. Historically, people used seals, thumb impressions or handwritten signatures to identify a particular person or to bind that person to a particular document such as agreements, contracts and likewise. The signature is an assertion stating that the person who has signed the document has read the document and agrees with the contents of the documents, more precisely to the terms and conditions. However, the handwritten signature may be subjected to forgery or duplicity.

Further, owing to the shift from paper-based transactions to non-paper based virtual transactions, more and more people and organizations started using digital or electronic documents instead of paper-based documents for conducting day-to-day transactions. To assure the validity and authenticity of the documents, the documents need to be signed by a concerned authorized person. The electronic signatures therefore subdued the use of physical signatures and become operative in most of the business units, organizations, various national as well as international portals to facilitate online transactions without the mandate of physically signing the documents.

As far as the business scenario is concerned, the decision makers and the authorized signers receive multiple documents to sign daily, where the documents may belong to a certain type, category, or process defined by an organization. At times when the recipient does not take an action on the document, the document signing transaction workflow easily piles-up. Multiple requests that are generally pre-scheduled and delivered on a weekly, monthly, or bi-annual basis for signature, if not taken action by the signer also increases the list of pending documents to be signed. As far as the current scenario is concerned, the recipient needs to sign and approve each of these requests from the individual email and clicking on the action tab for every other document. For signing or approving and pending document workflow transactions, the recipient needs to go to the email box, find the relevant email notification for the pending mail item, and then click on the review action to open the document in web browser, review and complete the signature process. For the next pending signature or approval item, the same process is repeated, wherein the user goes back to the email-box and searches for the email-notification. This causes delays and inefficiency wherein the recipient needs to spend time searching for acting on the pending document request signed-off and may miss some email review notifications while searching from email-box.

### PRIOR ART

US Patent Publication No. 2015/0295720 discloses a method for signing a digital message, and, if a request is approved, providing a time stamp, wherein computing a password sequence comprising a plurality of passwords such that each respective password corresponds to an index unit. The request is computed as a first function of the message and a current one of a sequence of passwords computed such that each password corresponds to an index unit. Each of the passwords may be computed as a function, such as a hash function, pseudo-random function, or encryption function, of the subsequent password, whereby the sequence terminates with an initial password that forms a public key parameter for the password sequence. At least one hash tree uses at least a subset of the passwords as inputs to a hash tree used to verify the passwords.

U.S. Pat. No. 10,880,093 discloses an electronic authentication system including an electronic document authentication watermark seal or signature line for confirming a document's signing within the view. It further discloses a system, software program, and method for generating electronic documents, coordinating the signing of electronic documents, digitally authenticating and certifying electronic documents, and organizing electronic documents for retrieval and transfer in a mortgage closing and/or other financial services application.

All the above patents talk about the electronic authentication of the documents and method of digitally signing of documents or applying time stamp on request. However, none of the systems provides a method for signing of the pending documents. For instance, when a large number of documents are simultaneously furnished into the signer's email inbox, the signer may miss out of a few important documents and there is a chance such documents remain ignored in the inbox as a pending document.

To overcome the evident technical drawbacks of the aforementioned systems and known traditional methods of e-signing as stated above, the present system and method provides a technical solution to the same.

### Definitions

For the purpose of the present invention, the various terms used throughout the invention are defined as follows:

“Document” refers to an electric document.

“Pending document” refers to any document which is yet to be signed or approved by the recipient and can be still seen in the pending transaction in the users' screen or user window.

“User” refers to any person including but not limited to, a sender, recipient, signer or employees, whosoever is enabled to access the system and/or method of the present invention.

“Sender” refers to the person who is the originator of the document, i.e., the person who sends the document to be electronically signed to the signer, defines the signing workflow and also selects the values for metadata fields for grouping of documents.

“Recipient” refers to any person who is required to review the details and particulars mentioned in a document and is authorized to sign the documents for providing approval or validating the documents, and may include but not limited to, a manager or a senior executive so to say.

“Internal recipient” refers to any person who is an employee belonging to the same organization.

“External recipient” refers to any person who is other than an employee belonging to a different organization.

“Network” refers to a group or a system also including but not limited to interconnected people or things.

“Input device” and “output device” refers to anything including, but not limited to a computer system, a mobile device, a user interface (UI), web-screens, servers like hosting servers and more, that enable access to any centralized resource, system, or service within a network.

“Metadata” refers to collective information about multiple databases related to different fields, such as entity based, business unit based, contract types including and not limited to—vendor contracts, procurement contracts, customer contracts, partner contracts, marketing contracts, IT contracts, non-disclosure agreements (NDAs), value-based contracts, department based contracts and any additional user specific data, where such metadata is used to segregate a large number of documents into relevant groups for ease in the signing of large numbers documents.

“Transaction” herein refers to a group of documents formed as a result of metadata field mapping, to which a signature has to be applied for approval, and thereby the term “transaction” is alternatively used to depict two or more documents in the present description.

“Signature” refers to an electronic signature that is applied using an electronic device such as a computer, mobile devices, smart cards, and the like, to authenticate the signatory and certify the integrity of the document.

“Workflow” refers to a stepwise method to be performed for obtaining a specific output using a defined system.

“Sequence” refers here as display of a set of pending documents to be signed one after the other based on a first come-first serve basis such that none of the pending document can be ignored and left devoid of the signature for approval.

### OBJECTIVES OF THE INVENTION

An object of the present invention is to provide a system and method for electronic signing of electronic documents.

Yet another object of the present invention is to provide a system and method for sequential signing of the pending transactions at recipients' end.

Yet another object of the present invention is to provide a system and method for grouping of similar documents.

Yet another object of the invention is to provide a 2-Factor authentication for validating the recipient signing the transaction.

Yet another object of the invention is to provide the details of all the pending transactions for a particular recipient on a single screen.

Yet another object of the invention is to continuously add the pending transaction one after the other sequentially to the recipients' web-screen as a previous transaction is completed.

Yet another object is to provide a time-saving, convenient method for signing multiple transactions pending at the recipients' end in a sequential manner.

### SUMMARY OF THE INVENTION

The present invention relates to electronic signing of electronic documents and in particular to a system (1) and method to perform sequential signing of e-documents which are pending for recipients' action.

In one aspect, the system (1) and method of the present invention employs a signature workflow transaction (8) using a sequential signature feature (12) through a processing unit (6) of the system (1) where a sender (2) sends a signature workflow transaction (8) to be signed and the recipient (3) selects at least one transaction from a pending workflow transactions' (8) list displayed by the sequential signature feature (12) on the recipients' web screen (7) and apply a signature thereby approving the documents (5), generating an audit report and sending a transaction confirmation email to the sender (2) and recipient (3) of the transaction.

In another aspect, the system (1) and method of the present system provides a 2-factor authentication step to verify that the transaction is signed by the relevant recipient (3) by validating the details including either a mobile number or an email id or both, before proceeding for signing of the transaction such that the user need not authenticate again for the next document (5) selected in case the user had authenticated using the same 2-factor authentication for the previous transaction completed in the same active user session.

In yet another aspect, the system (1) and method of the present system employs a sequential signature feature (12) through a processing unit (6) of the system (1) providing pending workflow transactions (8) one after the other in a sequential manner for signing multiple pending workflow transactions (8) at recipients' (3) end.

In yet another aspect, the system (1) and method of the present system generates and displays an audit report of the completed transactions on the users' web-screen (7), wherein the audit report captures all logs information such as IP address of the sender (2) as well as recipient (3), time stamps, date and time of signing a particular transaction.

In yet another aspect, the system (1) and method of the present system provides an efficient, time-saving, convenient method for signing multiple transactions pending at the recipients' (3) end in a sequential manner and allowing the recipient (3) to view all the transaction pending for his/her signature on a single screen enabling the transactions to appear one after the other in sequence assuring that none of the transactions are left unapproved and devoid of signature.

### BRIEF DESCRIPTION OF THE DRAWINGS

FIG. 1 illustrates a schematic view of the system of the present invention.

FIG. 2 illustrates a schematic view of the various components of the system and their arrangement over a network.

FIG. 3 illustrates a schematic view of a detailed flowchart of the workflow involving the steps of sequential signing of the documents/transactions pending at the recipients' end.

FIG. 4 is a schematic view of an exemplary illustration of the web-screen that shows the grouped pending transactions on the recipients' screen and the sequential signature workflow.

### DETAILED DESCRIPTION OF THE INVENTION

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention.

Throughout this specification, the word “comprise,” or variations such as “comprises” or “comprising,” will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

For any virtual transaction to be validated and approved, an authorized person needs to sign and approve the documents. These approval requests are usually sent to the decision makers such as the managers or senior executives through emails for each transaction. In an organization where these decision makers are required to review a larger number of documents per day, the approval of transactions by e-signing becomes a procedural part. To assist the decision makers in signing-off the pending documents in a more efficient manner, the present system provides a sequential e-signature feature that enables signing of the transactions pending at the recipients' end one after the other sequentially.

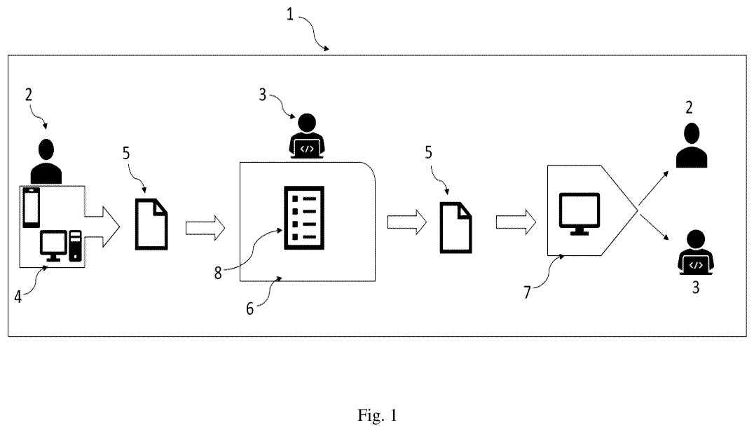

The system (1) and method of the present invention can be understood more clearly with reference to the drawings included with the present description and the various embodiments emphasizing the various aspects of the invention. An embodiment of the invention discloses the present system (1) as illustrated in FIG. 1, comprising a sender (2) of the transaction, a recipient (3) of the transaction, an input device (4), an output device (7), document (5) and a processing unit (6), where the sender (2) sends a signature workflow transaction (8) to be signed and selects values for metadata (11) fields using an input device (4) whereafter the recipient (3) selects any one of the transactions from the list of pending workflow transactions (8) displayed on a web screen (7) of the e-signature feature (12) where the transactions refers to the documents (5) grouped using a processing unit (6) by applying the metadata (11) field values, followed by a 2-factor authentication of the recipient (3) and thereby applies the signature to the documents (5) and sends the transaction completion conformation email to the sender (2) and recipient (3) using an output device (7).

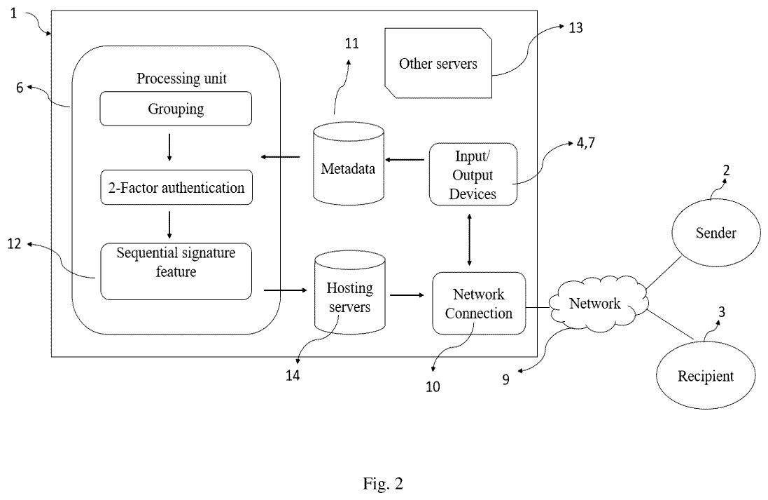

Additionally, an embodiment of the invention as illustrated in FIG. 2 also includes a network (9) allowing the sender (2) or the recipient (3) to interact with the system (1) through a network connection (10), where the system (1) also includes metadata (11), multiple servers (13), input/output devices (4,7) and sequential signature feature (12), where the metadata (11) is a collective information of one or more databases based on which the similar documents (5) can be segregated in one or more groups and the server (13) includes at least one hosting server (14) for storing documents (5).

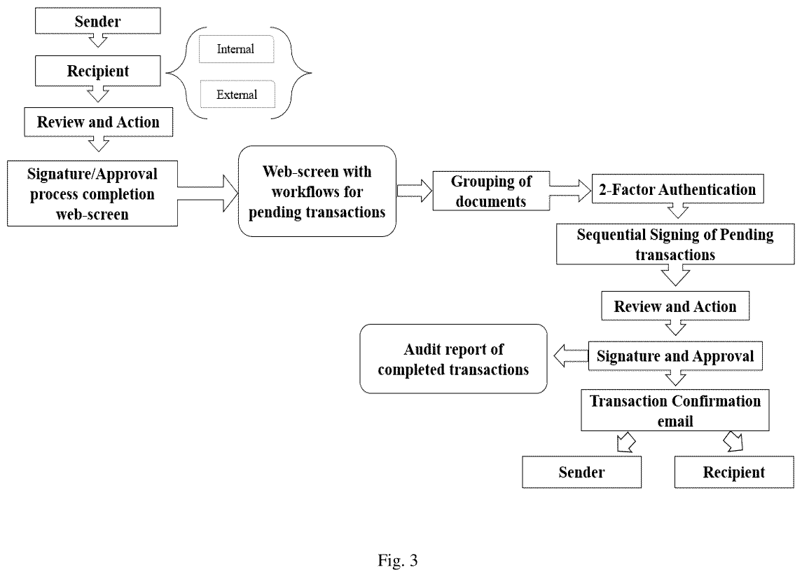

In all the preferred embodiments of the present invention described herein, a method for electronically signing documents (5) using a sequential signature feature (12) of the present system (1) follows a defined workflow as illustrated in FIG. 3, comprising the steps as follows:

1. The sender (2) sends a signature workflow transaction (8) in the system (1) through at least one input device (4) using a network (9), and selects preferable values for metadata (11) fields.

2. The recipient (3) receives a link through an email for the transaction, i.e., a link for the documents (5) to be signed.

3. The recipient (3) clicks on the link to open the transaction web-screen (7) to review the transaction, and then applies signature to the transaction using an “action” button.

4. A signature or approval process completion web-screen (7) appears showing the reviewed and signed documents (5).

5. In the next step, the web-screen (7) displays the list of workflows for pending transactions which are required to be signed by that recipient (3).

6. At this step, the processing unit (6) segregates the documents (5) into relevant groups or transactions using the metadata (11) field mapping and then the recipient (3) proceeds for signing the transaction.

7. A 2-factor authentication is required by the system (1) to verify that the transaction is signed by the relevant recipient (3).

8. The recipient (3) then selects any one transaction from the pending transaction list as provided by the sequential signature feature (12) by clicking on the “action” button on the screen for applying signature.

9. Once the documents (5) are approved by applying signature, the system (1) generates an audit report of the completed transactions, and the next pending transaction in sequence appears on the recipients' (3) screen.

10. As one transaction is completed, the system (1) sends a “transaction confirmation email” to the sender (2) and the recipient (3).

11. The recipient (3) then continues signing the remaining pending transactions one by one as they are sequentially provided by the sequential signature feature (12) of the system (1).

Another embodiment of the invention describes the grouping within the processing unit (6) of the system (1). During the grouping of the pending transactions to be signed, the system (1) applies the values for metadata (11), previously selected by the sender (2) from a list of meta data fields including, but not limited to—region, legal entity, business units, document type whether it is vendor contracts, procurement contracts, customer contracts, partner contracts, marketing contracts, IT contracts, non-disclosure agreements (NDAs), value-based contracts, department-based contracts and any additional user specific data. The processing unit (6) of the system (1) then creates different transaction groups based on the senders' (2) inputs and displays the transactions on the web-screen (7) with workflows for pending transactions (8), enabling the recipient (3) or signer to sequentially sign the listed transactions. The embodiment of the invention further describes that after completion of the transaction by signing the documents (5), an audit report of the completed transactions is displayed by the sequential signing feature on the users' web-screen (7), wherein the audit report captures all logs information such as IP address of the sender (2) as well as recipient (3), time stamps, date and time of signing a particular transaction.

Another embodiment of the invention describes the 2-factor authentication step within the sequential signature workflow, where the system verifies the user using the details including either a mobile number or an email id or both, so as to authenticate the recipient (3) before proceeding for signing of the transaction. In a case where a 2-factor authentication method is involved for a particular transaction which was selected from the pending transaction list section, and the user had authenticated using the same 2-factor authentication method for the previous document/transaction completed in the same active user session, then the user need not authenticate again for the next document (5) selected. The same active user session herein implies a user session where the user/recipient (3) clicks on review from an email notification and completes the document (5) review and signing process, post which the system (1) displays the list of signature completion confirmation web-screen (7) of the reviewed and signed workflow transaction (8). Now, if the user proceeds to view the list of pending transactions and selects any one transaction for sequential signing, then the user is said to be in the same active user session.

Another embodiment of the present invention describes that the recipient (3) of the transaction is also the signer or decision maker including but not limited to, a manager or a senior executive, for approving that particular transaction or document (5), and the recipient (3) of the transaction includes either an internal recipient i.e. an employee within the same organization or an external recipient, i.e., a person other than an employee of the same organization, such that the display of groupings of pending documents (5) is visible only to the internal recipients.

### Advantages

The system (1) and method of the present invention provides an efficient, time-saving, convenient method for signing multiple transactions pending at the recipients' end in a sequential manner where the 2-factor authentication of the system (1) verifies the recipient before applying signatures to the transaction. It allows the recipient to view all the transaction pending for his/her signature on a single screen such that the transactions appear one after the other in sequence assuring that none of the transactions are left unapproved and devoid of signature.

### EXAMPLE

### Sequential Signing of Pending Transactions

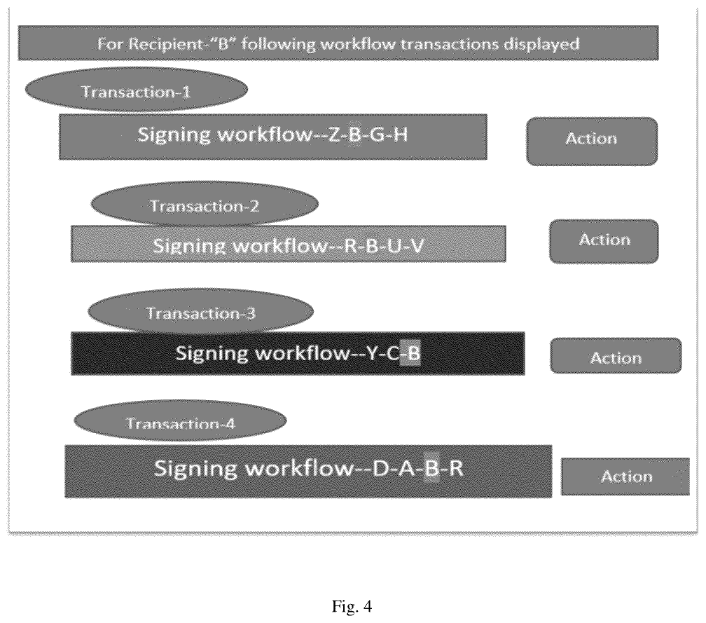

In case where the sender (2) sends a signature workflow transaction, the recipient (3) can sign various pending documents (5) sequentially so as to avoid missing out on any transaction to be signed and approved. For better understanding of the actual workflow, consider the following exemplary workflow for explanatory purposes with reference to FIG. 4, where:
Sender=S
Recipients/Signers=A, B, C, D, G, H, R, U, V, Y.
Transactions=1, 2, 3, 4.

It is to be noted that this is only an example and that in the actual scenario, the number of recipients and transactions can be variable than what is specified herein. Nevertheless, this example shall be used to explain all the important embodiments of the present invention.

For the purpose of the present example: A sender “S” sends multiple documents into the system using at least one input device through a network, where a processing unit of the present system segregates the documents using the metadata field mapping into various groups referred herein as “transactions”. Considering a case for a particular recipient say “B” as illustrated in FIG. 4, all the workflow transactions including a recipient “B” as one of the signers of the transaction are displayed on the web-screen of the recipient “B”. The signing workflows of the various transactions as shown on the web-screen of “B” are as follows:
Transaction 1: Z-B-G-H;
Transaction 2: R-B-U-V;
Transaction 3: Y-C-B;
Transaction 4: D-A-B-R;

where all the four transactions have “B” as one of the signers/recipients, and the transactions are to be signed preferably in a sequence as transaction 1 followed by transaction 2, 3 and then 4, but not limited to it.

If the recipient B selects from an email notification, say “transaction 1” having a workflow Z-B-G-H for signing, first the recipient has to validate himself using the 2-factor authentication method, followed by reviewing the “transaction 1” and applying signature using the “action” button adjacent to the respective transaction. Once the “transaction 1” is signed, an audit report is generated by the sequential signature feature and a confirmation email for notifying the “completed transaction” is sent to the sender and recipient of the transaction, and the “transaction 1” is removed from the pending list on the screen of recipient B.

Now the “transaction 2” having a workflow R-B-U-V ascends to the position of “transaction 1” whereafter the transactions 3 and 4 follow the same pattern, and a new transaction provided by the sequential signature feature, say D-B-R-Z adds up on the same screen as a next transaction sequence taking a position as “transaction 4,” thus continuously adding the pending transaction one after the other sequentially to the recipients' web-screen until all the transactions are signed by the recipient “B.” Similar steps are followed by any other or all recipients' say A, C, D, G, H and so on, for approving and signing the documents within various transactions using the sequential signature feature of the present system (1).

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for sequential signing of documents including a sender of the transaction, a recipient of the transaction, an input device, an output device, documents, a processing unit, a network connection and servers, comprising:
a processing unit that employs a sequential signature feature following a specific transaction workflow;
wherein the sender sends a signature workflow transaction to be signed and selects values for metadata fields using at least one input device, whereby the recipient selects at least one transaction from a pending workflow transactions list displayed by the sequential signature feature on the recipient's web screen; and
a 2-factor authentication validates the recipient thereby enabling him or her to apply a signature to the documents and sends a transaction completion conformation email to the sender and recipient using the output device;
wherein the system facilitates the grouping of documents into transactions using metadata field mapping, 2-factor authentication of the recipient and employing sequential transaction workflow for signing multiple pending workflow transactions at the recipient's end;
wherein one after the other in a sequential manner as provided by the sequential signature feature.

2. The system as claimed in claim 1, wherein the processing unit enables segregating the similar documents within relevant groups referred as transactions, pending to be signed where the system applies the values for metadata based on the sender's inputs previously selected from a list of meta data fields including, region, legal entity, business units, document type whether it is vendor contracts, procurement contracts, customer contracts, partner contracts, marketing contracts, IT contracts, non-disclosure agreements (NDAs), value-based contracts, department-based contracts and any additional user specific data, and displays the transactions on the web-screen with workflows for pending transactions, enabling the recipient or signer to sequentially sign the listed transactions.

3. The system as claimed in claim 1, wherein the system generates an audit report of the completed transactions displayed using the sequential signing feature on the user's web-screen such that the audit report captures all logs information including IP address of the sender as well as recipient, time stamps, date and time of signing a particular transaction.

4. The system as claimed in claim 1, wherein the system provides an efficient, time-saving, convenient method for signing multiple transactions pending at the recipients' end in a sequential manner with a 2-factor authentication of the recipient before applying signatures to the transaction and allows the recipient to view all the transaction pending for his or her signature on a single screen enabling the transactions to appear one after the other in sequence assuring that none of the transactions are left unapproved and devoid of signature.

5. A method for sequential signing of documents, comprising the steps of:
sending a signature workflow transaction in the system by a sender through at least one input device using a network;
selecting preferable values for metadata fields by the sender;
receiving a link by a recipient for a transaction to be signed through an email;
clicking on the link by the recipient to open a transaction web-screen to review the transaction;
applying signature to the transaction using an action button by the recipient;
displaying a signature or approval process completion web-screen showing the reviewed and signed documents;
displaying the web-screen with the list of workflows for pending transactions which are required to be signed by the recipient;
segregating of the documents by a processing unit into relevant groups or transactions using the metadata field mapping;
2-factor authentication of the recipient by the system before signing the transaction;
selecting any one transaction by the recipient from the pending transaction list as provided by the sequential signature feature;
clicking on the action button on the screen for applying signature;
generating an audit report of the completed transactions;
displaying the next pending transaction in sequence on the recipient's web-screen;
sending a transaction confirmation email to the sender and the recipient; and
repeating the signing steps for the remaining pending transactions one by one as they sequentially provided by the sequential signature feature of the system.

6. The method as claimed in claim 5, wherein the 2-factor authentication step within the sequential signature workflow to verify the recipient using details including either a mobile number or an email id or both, before proceeding for signing of the transaction where the user or recipient need not authenticate again for the next document to be signed if he or she has authenticated using the same 2-factor authentication details for the previous transaction completed in the same active user session.

7. The method as claimed in claim 5, wherein the method further comprises the step of generating an audit report of the completed transactions displayed using the sequential signing feature on the user's web-screen such that the audit report captures all logs information such as IP address of the sender as well as recipient, time stamps, date and time of signing a particular transaction.

8. The method as claimed in claim 5, wherein the method provides an efficient, time-saving, convenient method for signing multiple transactions pending at the recipient's end in a sequential manner with a 2-factor authentication of the recipient before applying signatures to the transaction and allows the recipient to view all the transaction pending for his or her signature on a single screen enabling the transactions to appear one after the other in sequence assuring that none of the transactions are left unapproved and devoid of signature.
